(19) United States
(12) Patent Application Publication
(10) Pub. No.: US 2013/0046450 A1
(43) Pub. Date: Feb. 21, 2013

(54) DRIVING RESISTANCE-DEPENDENT SHIFTING DELAY

(71) Applicants: Martin GENTILE, Ruesselsheim (DE); Gernot BECKER, Mainz (DE)

(72) Inventors: Martin GENTILE, Ruesselsheim (DE); Gernot BECKER, Mainz (DE)

(73) Assignee: GM GLOBAL TECHNOLOGY OPERATIONS LLC, Detroit, MI (US)

(21) Appl. No.: 13/585,018

(22) Filed: Aug. 14, 2012

(30) Foreign Application Priority Data
Aug. 16, 2011 (DE) 10 2011 110 610.7

(51) Int. Cl. F16H 59/44; F16H 59/50; F16H 59/48; G06F 17/00

(52) U.S. Cl. 701/56; 701/58

(57) ABSTRACT

A control system for shifting an automatic transmission for a motor vehicle is provided. The control system is connected to a drive engine and a drive train. The control system includes a speed sensor configured for sensing a vehicle speed, an angular sensor configured for sensing an angle of an accelerator pedal of the motor vehicle, an acceleration sensor configured to sense an acceleration of the accelerator pedal, and a control electronic device configured for selecting a predetermined shifting curve for shifting the automatic transmission. The control electronic device also is configured to select from different shifting modes by measurement data of the speed sensor, angular sensor, and acceleration sensor.

### CROSS-REFERENCE TO RELATED APPLICATION

This application claims priority to German Patent Application No. 10 2011 110 610.7, filed Aug. 16, 2011, which is incorporated herein by reference in its entirety.

### TECHNICAL FIELD

The technical field relates to a driving resistance-dependent shifting delay, in particular a driving resistance-dependent shifting delay for an automatic transmission of a motor vehicle.

### BACKGROUND

An automatic transmission is a conventional manual transmission wherein the control of the clutch and the changing of the gear are no longer brought about by the driver, but by actuators or hydraulics. During the gear change, the tractive force, exactly as with conventional manual transmissions, is interrupted and the shifting time is determined by the time of the gear change plus the time for the clutch actuation. A driver can merely select the gear.

The shifting, in particular the upshifting of gears in the case of an automatic transmission, can be achieved with the help of shifting curves. The shifting, in particular upshifting in this case, is effected as a function of the speed of the vehicle and the position of the accelerator pedal. The term accelerator pedal describes a pedal that controls the power of the engine.

As soon as the transmission control sends a shifting signal, a shifting time of approximately 500 milliseconds (ms) starts. However, the rotational speed of the engine increases during the shifting so that the shifting point has to be calibrated before the optimum rotational speed of the engine is reached. This can take place for example during shifting, in particular during upshifting, under full load of the engine or during a kick down driving with a loose torque converter.

In order to shorten the delay of the shifting time, lower shifting points, in particular upshift points are used in the shifting curves. The lower shifting points, in particular upshift points, of the shifting curve in this case have a lower value than the optimum shifting point. Because of this, no optimum shifting, in particular optimum upshifting, can be achieved for all driving conditions, for example while driving uphill or downhill. In the worst case, the governed rotational speed of the engine can be achieved through the shifting of the automatic transmission, for example at full load of the engine when the motor vehicle travels downhill, for the motor vehicle accelerates faster and the shifting time remains the same with all shifting operations.

Moreover, with the current equalization of the shifting time, the driving resistance is not taken into account. Driving resistance describes the sum of the resistances which a motor vehicle has to overcome with the help of a driving force in order to travel on a horizontal plane with a constant or accelerated speed. Compared to a level road, the driving resistance of the vehicle is lowered for example when driving downhill while it is increased when driving uphill. The shifting time for each shifting operation however remains the same with all driving resistances, which means no distinction is made as to whether the motor vehicle travels on a level road, travels uphill or travels downhill. Because of this, in the worst case, the governed rotational speed of the engine can be reached through the shifting of the automatic transmission, for example at full load of the engine when the motor vehicle travels downhill.

At least one object herein is to provide a control system for shifting, in particular for upshifting, an automatic transmission, wherein no compromises during the calibration of the shifting points, in particular of the upshift points, have to be made during different driving resistances.

### SUMMARY

An exemplary embodiment relates to a control system for shifting, in particular for upshifting, an automatic transmission for motor vehicles. The control system is connected to a drive engine and a drive train, a speed sensor for sensing the vehicle speed and an angular sensor for sensing the angle of an accelerator pedal, and a control electronic device for selecting a predetermined shifting curve for shifting the automatic transmission. An acceleration sensor is provided, which senses an acceleration of the accelerator pedal, wherein the control electronic device by measurement data of the speed, angular and acceleration sensors selects from different shifting modes. Because of this, the control system can select a shifting point that corresponds to the current driving state of the motor vehicle.

The term accelerator pedal describes a pedal that controls the power of the engine. The term shifting modes describes a multiplicity of shifting points from which the control electronic device can select in order to shift, in particular upshift, the automatic transmission. The timing of the shifting, in particular of the upshifting, in this case can be negatively or positively delayed depending on the vehicle state. For example, the timing of the shifting can be negatively delayed in the case of a motor vehicle driving downhill, while the timing of the shifting is positively delayed when driving uphill. Because of this, the optimum rotational speed of the engine during shifting, in particular during upshifting, of the automatic transmission can be achieved at any time. The term negative delay in this case describes a state wherein the shifting time is delayed before the optimum shifting point. This is required for example when the vehicle travels downhill. The term positive delay describes a state wherein the shifting time is delayed after the optimum shifting point. The term delay can, for example, be a delay of the time or a deceleration of the speed of the vehicle.

In an embodiment, the control electronic device determines a driving resistance through a comparison of the acceleration of the vehicle with a theoretical acceleration. The driving resistance describes the sum of the resistances which a motor vehicle has to overcome with the help of a driving force in order to travel on a horizontal plane with a constant or accelerated speed. Compared to a level road, the driving resistance of the vehicle when driving downhill, for example, is lowered while it is increased when driving uphill. By comparing the current acceleration of the vehicle with a theoretical acceleration of the vehicle, wherein the theoretical acceleration, for example, is based on a theoretical acceleration on a level road, the control electronic device can establish if the motor vehicle travels uphill or downhill for example. With the help of this information, the control unit can negatively or positively delay the timing for the shifting, in particular upshifting. For example, on detecting a motor vehicle driving downhill the shifting time can be negatively delayed or in the case of a vehicle driving uphill, the shifting time can be positively delayed in order to achieve an optimum shifting, in particular upshifting. Thus it can be possible at any time to achieve the optimum rotational speed of the engine for a shifting, in particular upshifting, of the automatic transmission. Because of this it is no longer necessary to make compromises with the calibration of shifting points, in particular upshift points. Because of this it is possible, in addition, because of the optimum shifting points, to achieve a faster acceleration from 0 km/h to 100 km/h.

In an embodiment, the control electronic device is configured such that the control electronic device determines the acceleration of the accelerator pedal upon a change of the angle of the accelerator pedal. Because of this, the control electronic device can detect the driving state of the vehicle. For example, it may be necessary while driving uphill to fully depress the accelerator pedal or for example when driving downhill to take the foot off the accelerator pedal. This can result in a change of the gear of the automatic transmission.

In another embodiment, it is determined in the shifting modes by how many gears the automatic transmission will shift. Because of this the control electronic device can determine the optimum timing for shifting, in particular upshifting. Thus it can be necessary, for example, to not only shorten or delay the shifting time for an optimum shifting point but, for example, to skip a plurality of gears as well. This can be advantageous for example during a kick down, so that the motor vehicle does not jerk or so that the engine does not generate loud noises.

In an embodiment, a device for shifting, in particular for upshifting, with an automatic transmission for a motor vehicle and a control system for shifting, in particular for upshifting, an automatic transmission for motor vehicles, which is connected to a drive engine and a drive train is provided.

A further embodiment relates to a vehicle, with a control system for shifting, in particular upshifting, of an automatic transmission for motor vehicles, which is connected to a drive engine and a drive train.

Furthermore, an embodiment relates to a method for controlling the shifting, in particular the upshifting, of an automatic transmission, comprising the steps:
sensing the speed of the vehicle,
sensing the angle of the accelerator pedal,
sensing the acceleration of the accelerator pedal,
transmitting the sensed measurement data to the control electronic device,
evaluating the transmitted measurement data in the control electronic device,
calculating a timing for shifting, in particular upshifting
shifting of the automatic transmission according to the calculated value.

With the help of the method, the control system can select a shifting point which corresponds to the current driving state of the motor vehicle. The timing of the shifting, in particular of the upshifting, in this case can be delayed negatively or positively depending on the vehicle state, for example the timing of the shifting can be negatively delayed when the vehicle travels downhill, while the timing of the shifting can be positively delayed when the vehicle travels uphill. Because of this, the optimum rotational speed of the engine for shifting, in particular for upshifting of the automatic transmission can be achieved at any time. The term negative delay in this case describes a state wherein the shifting time is delayed before the optimum shifting point, for example this is required when the vehicle travels downhill. The term positive delay describes a state wherein the shifting time is delayed after the optimum shifting point. The term delay can for example be a delay of the time or a deceleration of the speed of the vehicle.

With the method, the speed of the vehicle, the angle of the accelerator pedal and the acceleration of the accelerator pedal can be preferentially sensed via at least one speed sensor, via at least one angular sensor and via at least one acceleration sensor. Because of this, the driving state of the vehicle can be sensed with the help of the method. It may be necessary, for example, while driving uphill to fully depress the accelerator pedal or for example when driving downhill to take the foot off the accelerator pedal. This can result in a change of the gear of the automatic transmission.

In an embodiment of the method, the control system determines the acceleration of the accelerator pedal from the measurement data of the angular sensor. Because of this, the timing of the shifting, in particular of the upshifting, can be determined

In another embodiment of the method, the control system determines a driving resistance by comparing the acceleration of the vehicle with a theoretical acceleration. By comparing the current acceleration of the vehicle with a theoretical acceleration of the vehicle, wherein the theoretical acceleration for example is based on a theoretical acceleration on a level road, the control electronic device can determine if the motor vehicle is driving uphill or downhill for example. With the help of this information, the control unit, with the method, can negatively or positively delay the timing for the shifting, in particular for the upshifting. For example, on detecting a motor vehicle driving downhill, the shifting time can be negatively delayed or when driving uphill, the shifting time can be positively delayed in order to achieve an optimum shifting, in particular upshifting. Thus it is possible at any time to achieve the optimum engine rotational speed for a shifting, in particular upshifting of the automatic transmission. Because of this it is no longer necessary to make compromises with the calibration of shifting points, in particular upshift points during different driving states. Furthermore, it is possible because of the optimised shifting points to achieve a faster acceleration from 0 km/h to 100 km/h.

### BRIEF DESCRIPTION OF THE DRAWINGS

The various embodiments will hereinafter be described in conjunction with the following drawing figures, wherein like numerals denote like elements, and wherein:

FIG. 1 is a flow diagram of a control system in accordance with an exemplary embodiment; and

FIG. 2 is a flow diagram of a control system in accordance with another exemplary embodiment.

### DETAILED DESCRIPTION

The following detailed description is merely exemplary in nature and is not intended to limit the various embodiments or the application and uses thereof Furthermore, there is no intention to be bound by any theory presented in the preceding background or the following detailed description.

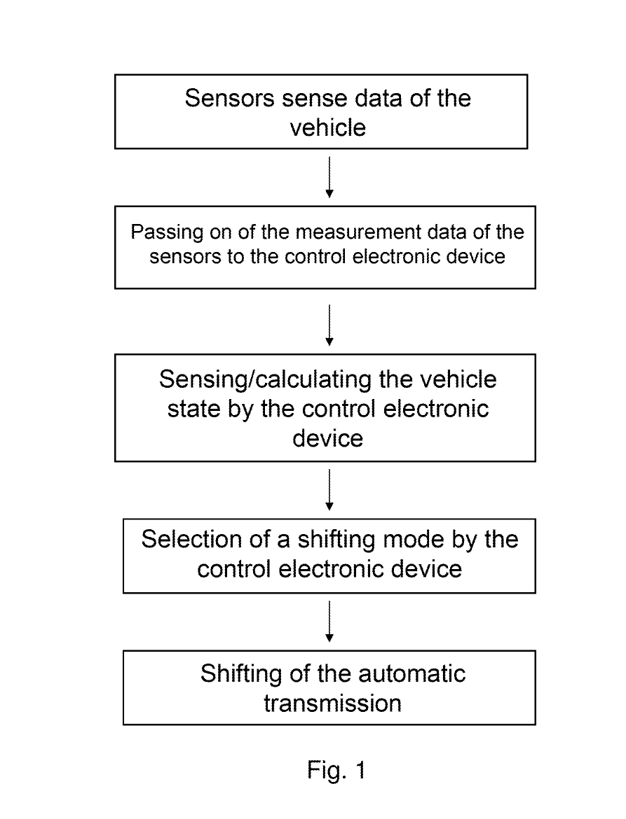

In accordance with an exemplary embodiment, FIG. 1 shows a flow diagram for a control system 10 for shifting, in particular upshifting, an automatic transmission for motor vehicles. The control system 10 is connected to a drive engine and a drive train. Here, the control system comprises a speed sensor 12 in order to sense the vehicle speed, and an angular sensor 14, in order to sense the angle of an accelerator pedal 20. Furthermore, an acceleration sensor 18 is provided in the control system, which senses an acceleration of the accelerator pedal 20. The term accelerator pedal 20 in this context describes a pedal which controls the power of the engine. The measurement data of the sensors are passed on to a control electronic device 16. The control electronic device 16 senses and calculates the vehicle state of the motor vehicle by the measurement data of the sensors. The control electronic device 16 is able by the measurement data to determine if the vehicle is driving uphill, downhill or on a level road. By the calculated vehicle state the control electronic device 16 is able to determine the optimum timing for the optimum shifting, in particular upshifting, of the automatic transmission from a multiplicity of shifting modes. Because of this, the control system can select a shifting point which corresponds to the current driving state of the motor vehicle. The term shifting modes describes a multiplicity of shifting points, from which the control electronic device 16 can select in order to shift, in particular upshift, the automatic transmission. With the help of the control system 10 it is possible to determine an optimum timing for shifting, in particular upshifting the automatic transmission. The control system 10 by the measurement data of the sensors can determine the vehicle state and because of this also determine the driving resistance of the motor vehicle, and because of this determine an optimum timing for shifting, in particular upshifting. The driving resistance describes the sum of the resistances which a motor vehicle has to overcome with the help of a driving force in order to travel on a horizontal plane with a constant or accelerated speed. Compared with a level road, the driving resistance of the vehicle, for example, when driving downhill is lowered while it is increased when driving uphill. With the help of this information, the control unit can negatively or positively delay the timing for the shifting, in particular upshifting. On detecting a motor vehicle driving uphill for example, the shifting time can be negatively delayed or in the case of a vehicle driving uphill, the shifting time can be positively delayed in order to achieve optimum shifting, in particular upshifting. Thus, it can be possible at any time to achieve the optimum engine rotational speed for shifting, in particular upshifting, the automatic transmission. Because of this it is no longer necessary to make compromises with the calibration of shifting points, in particular upshifting points. The term negative delay in this case describes a state wherein the shifting time is delayed before the optimum shifting point, which is required for example when the vehicle travels downhill. The term positive delay describes a state wherein the shifting time is delayed after the optimum shifting point. The term delay can for example be a delay of the time or a deceleration of the speed of the vehicle.

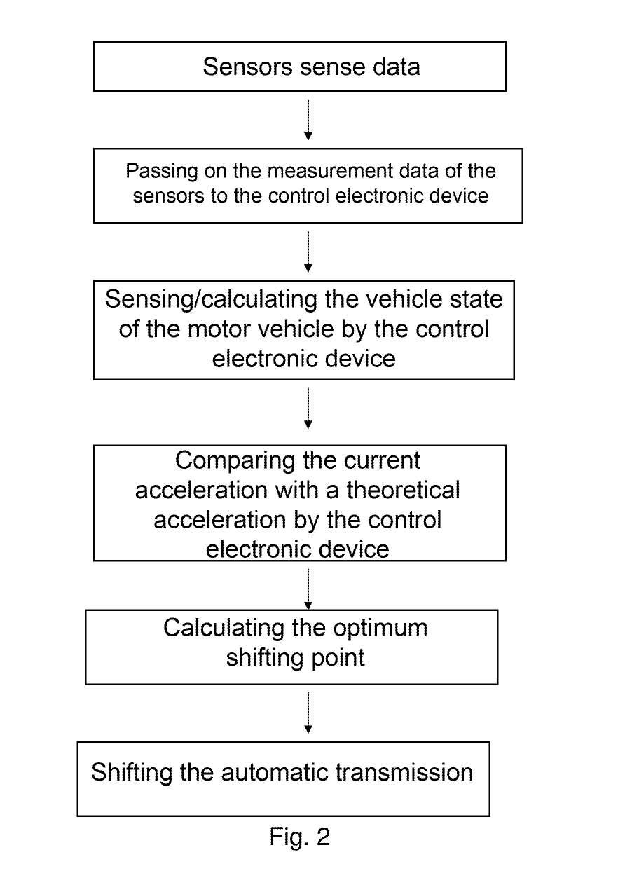

FIG. 2 shows a flow diagram for a control system 10 for shifting, in particular for upshifting, an automatic transmission for motor vehicles according to another embodiment. The control system 10 is connected to a drive engine and a drive train. The control system in this case comprises a speed sensor 12 in order to sense the vehicle speed, and an angular sensor 14 in order to sense the angle of an accelerator pedal 20. Furthermore, an acceleration sensor 18 is provided in the control system, which senses an acceleration of the accelerator pedal 20. The term accelerator pedal 20 in this context describes a pedal that controls the power of the engine. The measurement data of the sensors are passed on to a control electronic device 16. The control electronic device 16 senses and calculates the vehicle state of the motor vehicle by the measurement data of the sensors. The control electronic device 16 is able to determine by the measurement data if the vehicle travels uphill, downhill or on level road. The control electronic device 16 compares the acceleration of the vehicle with a theoretical acceleration of the vehicle on a level road. With the help of the comparison, the control electronic device 16 is able to negatively or positively delay the timing for shifting, in particular for upshifting, so that during the shifting, in particular during the upshifting, the optimum rotational speed of the engine is present. This is particularly advantageous with a shifting, in particular upshifting, at full load of the engine or during kick down driving. The delay of the timing of the shifting, in particular of the upshifting, can for example be effected through a delay of the shifting time or a deceleration of the speed of the vehicle. As soon as the control electronic device 16 has calculated the optimum shifting time, the control electronic device 16 shifts the automatic transmission at the calculated time.

In an embodiment which is not shown, the control electronic device 16 of the control system 10 can be configured in such a manner that the control electronic device 16 determines the acceleration of the accelerator pedal 20 by way of a change of the angle of the accelerator pedal 20. Because of this, the control electronic device 16 can detect the driving state of the vehicle. For example, it may be necessary when driving uphill to fully depress the accelerator pedal 20 or for example when driving downhill, to take the foot off the accelerator pedal 20. This can result in a change of the gear of the automatic transmission, wherein depending on the driving state of the motor vehicle, an adapted optimum timing for shifting, in particular for upshifting, is required.

In a further embodiment of the control system 10 which is not shown, it is determined in the shifting modes by how many gears the automatic transmission will shift. Because of this, the control electronic device 16 can determined the optimum shifting point for shifting, in particular for upshifting as a function of the driving resistance. Thus, it may be necessary for example for an optimum shifting point not only to negatively or positively delay the shifting time, but also to skip a plurality of gears for example. This can be advantageous for example during a kick down, so that the motor vehicle does not jerk or the engine does not generate loud noises.

In another embodiment, a device for shifting, in particular for upshifting, with an automatic transmission for a motor vehicle and a control system 10 is provided.

In a further embodiment, a vehicle with a control system 10 for shifting, in particular for upshifting, an automatic transmission for motor vehicles is provided.

In another embodiment, a method for controlling the shifting, in particular the upshifting, of an automatic transmission comprises the steps of sensing the speed of the vehicle, the angle of the accelerator pedal 20, the acceleration of the accelerator pedal 20, transmitting the sensed measurement data to the control electronic device 16, evaluating the transmitted measurement data in the control electronic device 16, calculating a timing for shifting, in particular upshifting, and shifting the automatic transmission according to the calculated value. With the help of the method, the control system 16 can select a shifting point which corresponds to the current driving state of the motor vehicle. The timing of the shifting, in particular of the upshifting, in this case can be negatively or positively delayed depending on the driving state, for example the timing of the shifting can be negatively delayed in the case of a motor vehicle driving downhill, while the timing of the shifting is positively delayed with a vehicle driving uphill. Because of this, the optimum rotational speed of the engine during shifting, in particular during upshifting, the automatic transmission can be achieved at any time. The term negative delay in this case describes a state wherein the shifting time is delayed before the optimum shifting point, for example this is required when the vehicle travels downhill. The term positive delay describes a state wherein the shifting time is delayed after the optimum shifting point. The term delay, for example, can be a delay of the time or a deceleration of the speed of the vehicle. The speed of the vehicle, the angle of the accelerator pedal 20, and the acceleration of the accelerator pedal 20 are sensed with the method via at least one speed sensor 12, via at least one angular sensor 14, and via at least one acceleration sensor 18. In addition, the control system can determine the acceleration of the accelerator pedal 20 from the measurement data of the angular sensor 14. With the method, the control system 10 determines a driving resistance through a comparison of the acceleration of the vehicle with a theoretical acceleration. Through the method, it is no longer necessary to make compromises with respect to the calibration of shifting points, in particular upshifting points, during different driving states. Furthermore, it is possible because of the optimised shifting points to achieve a faster acceleration from 0 km/h to 100 km/h.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A control system for shifting an automatic transmission for a motor vehicle, the control system connected to a drive engine and a drive train and comprising:
a speed sensor configured for sensing a vehicle speed;
an angular sensor configured for sensing an angle of an accelerator pedal of the motor vehicle;
an acceleration sensor configured to sense an acceleration of the accelerator pedal; and
a control electronic device configured for selecting a predetermined shifting curve for shifting the automatic transmission and configured to select from different shifting modes by measurement data of the speed sensor, the angular sensor, and the acceleration sensor.

2. The control system according to claim 1, wherein the control system is configured for upshifting the automatic transmission for the motor vehicle.

3. The control system according to claim 1, wherein the control electronic device is configured to determine a driving resistance through a comparison of the acceleration of the motor vehicle with a theoretical acceleration.

4. The control system according to claim 1, wherein the control electronic device is configured to determine the acceleration of the accelerator pedal by a change of the angle of the accelerator pedal.

5. The control system according to claim 1, the control electronic device is configured to determine within the different shifting modes a number of gears the automatic transmission will shift.

6. A vehicle with a control system for shifting an automatic transmission of the vehicle, the control system connected to a drive engine and a drive train and comprising:
a speed sensor configured for sensing a vehicle speed;
an angular sensor configured for sensing an angle of an accelerator pedal of the vehicle;
an acceleration sensor configured to sense an acceleration of the accelerator pedal; and
a control electronic device configured for selecting a predetermined shifting curve for shifting the automatic transmission and configured to select from different shifting modes by measurement data of the speed sensor, the angular sensor, and the acceleration sensor.

7. The vehicle according to claim 6, wherein the control system is configured for upshifting the automatic transmission for a motor vehicle.

8. The vehicle according to claim 6, wherein the control electronic device is configured to determine a driving resistance through a comparison of the acceleration of the vehicle with a theoretical acceleration.

9. The vehicle according to claim 6, wherein the control electronic device is configured to determine the acceleration of the accelerator pedal by a change of the angle of the accelerator pedal.

10. The vehicle according to claim 6, the control electronic device is configured to determine within the different shifting modes a number of gears the automatic transmission will shift.

11. A method for controlling the shifting of an automatic transmission of a vehicle, the method comprising the steps of:
sensing a speed of the vehicle, an angle of an accelerator pedal of the vehicle, and an acceleration of the accelerator pedal of the vehicle to obtain sensed measurement data;
transmitting the sensed measurement data to a control electronic device;
evaluating the sensed measurement data in the control electronic device;
calculating a timing for shifting to obtain a calculated value; and
shifting the automatic transmission according to the calculated value.

12. The method according to claim 11, wherein the speed of the vehicle, the angle of the accelerator pedal, and the acceleration of the accelerator pedal are sensed via at least one speed sensor, via at least one angular sensor and via at least one acceleration sensor.

13. The method according to claim 12, wherein the acceleration of the accelerator pedal is determined from measurement data of the at least one angular sensor.

14. The method according to claim 11, further comprising determining a driving resistance by comparing an acceleration of the vehicle with a theoretical acceleration.

15. The method according to claim 11, wherein the step of shifting comprises the step of upshifting.
